(19) United States
(12) Patent Application Publication
(10) Pub. No.: US 2001/0032139 A1
(43) Pub. Date: Oct. 18, 2001

(54) Cybermoney network; a seamless internet commercial and investment bank account connectivity interface for payment and settlement of goods and services purchased via the internet

(76) Inventor: Allison P. Debonnett JR., Chicago, IL (US)

Correspondence Address: ALLISON DEBONNETT JR., SUITE 100, ROOM 266, 47 WEST POLK STREET, CHICAGO, IL, 60605, US

(21) Appl. No.: 09/727,050

(22) Filed: Nov. 30, 2000

Related U.S. Application Data
(60) Provisional application No. 60/168,888, filed on Dec. 3, 1999.

(51) Int. Cl. G06F 17/60

(52) U.S. Cl. 705/26; 705/35

(57) ABSTRACT

Unlike many systems requiring traditional mediums of payment and settlement, this INTERNET based payment methodology is predicated on the invention of an agnostic demand deposit and cash management account connectivity interface for payment and settlement of goods and services purchased over the INTERNET. The system is comprised of secure network server topology for enabling payment and settlement of INTERNET based transactions. Irrespective of INTERNET connectivity device, when an INTERNET purchaser engages an INTERNET merchant for the purchase of goods or services, the network interface provides for seamless connection to commercial/investment bank checking, savings, merchant or cash management accounts for payment. The system is not predicated on any credit or debit/smart card facilities. Access to network incorporates emerging biometric technologies such as iris/retina scans, voiceprints, fingerprints as well as password entry constructs.

### BACKGROUND OF INVENTION

Despite the present use of traditional currency, credit cards, debit/smart cards and hybrid Internet payment systems developed by DigiCash and CyberCash, we propose a unique and efficient payment method to facilitate the optimum use of the INTERNET network platform. We have composed a system that enables seamless INTERNET commercial/investment bank account access by means of a universal demand deposit account (DDA)/cash management account (CMA) connectivity/interface, called CyberMoney™ Network. Whereby INTERNET customers would utilize the CyberMoney™ Network interface for accessing established checking, savings, or cash management accounts to pay for goods and services purchased, viewed or delivered via the INTERNET. Furthermore, as this system becomes accepted in the marketplace, clients will seek to utilize the currency exchange/conversion features exclusively via a conversion facility which, allow customers to convert world currency account values dynamically.

Predominately, most on-line vendors require customers to enter financial data such as credit card and mailing information for transaction payment, settlement and delivery. The vendor then stores this information to be used in later transactions with the same customer. We believe that the time it takes for a customer to enter this information inhibits the efficient use of e-commerce opportunities. Though INTERNET credit card clearing facilities exist, many consumers are reluctant to transmit financial information (including credit card, banking, residence, etc.) electronically without the verification that the information is secure and not subject to theft.

We strongly anticipate that our solutions will lead to greater access to products and services online, reduced reliance on customer service departments and reduced use of the various traditional inefficient payment systems. Additionally, our solutions reduce service and operational costs. According to a recent reports, the total aggregate cost to generate and reconcile a typical off-line payment invoice amounts to $75 as opposed to the cost of generating online payment solutions at $0.50 to $0.90 per transaction. By lowering financial channel partners and merchant transaction costs, CyberMoney payment solutions will encourage the continued growth and development of the global INTERNET economy.

Presently, there are few market players within our INTERNET space. As banking products, credit card interfaces and other proprietary solutions are deployed, we will have the ability to incorporate them into our network exchange solution. Furthermore, we do not perceive advent of eWallet distributors to be competitors in this space. Instead, eWallets will be distribution channels for CyberMoney™ account connectivity technology. While some companies are developing on-line payment systems, our business model is unique in that financial channel partners have the ability to private brand their CyberMoney™ market presence. This sets our business paradigm apart from any other prospective business competitor or business model and provides a ready-made market of strategic alliance partners in the form of eWallet producers.

### BRIEF SUMMARY OF INVENTION

This alternative payment methodology provides unique utility and standardization. We have developed a business method for universal and private-branded customer relationship management enhancement for commercial banks, investment banks and online brokerage customers; thus, creating a global Internet transaction payment solution for direct and seamless Demand Deposit Account(DDA)/Cash Management Account(CMA) connectivity interface for Business-to-Business(B2B), Business-to-Consumer(B2C) or Business-to-Exchange(B2E) purchases via the INTERNET. We prescribe a new standard of “INTERNET Payment Solutions”, enabling the global transfer and exchange of stored forms of value. This network system will not be predicated on credit nor debit card clearing.

This system of seamless integration will allow private branding, differentiation of services, cooperation and standardization of payment between financial institutional syndicate members and INTERNET merchants. As a result, a global standardized method of transaction payment and reconciliation will bring order and operational efficiencies to INTERNET e-commerce. The syndicate of financial channel members shall share in saving substantial operational cost by foregoing the cost of deploying various proprietary and non-standardized network facilities. Unlike many integration attempts to provide Internet banking platforms similar to the brick & mortar business model or banking public/private key repositories, the CyberMoney™ Network focuses on a DDA and CMA INTERNET connectivity methodology, providing robust value-adds to online banking initiatives.

### BRIEF DESCRIPTION OF VIEWS OF DRAWINGS

FIG. 1 is a flowchart comprised of web site interaction logic for new and existing network users.

FIG. 2 is the detailed network payment and settlement process data flow.

FIG. 3 represents the network architecture and server topology.

FIG. 4 is comprised of the graphical depiction of the various empowered network account types.

FIG. 5 illustrates the various INTERNET connectivity mediums in which the network can be accessed.

FIG. 6 denotes the application architecture of the network application programming interface components.

FIG. 7 represents the global banking syndication method for distributing network connectivity.

### DETAILED DESCRIPTION OF DRAWINGS

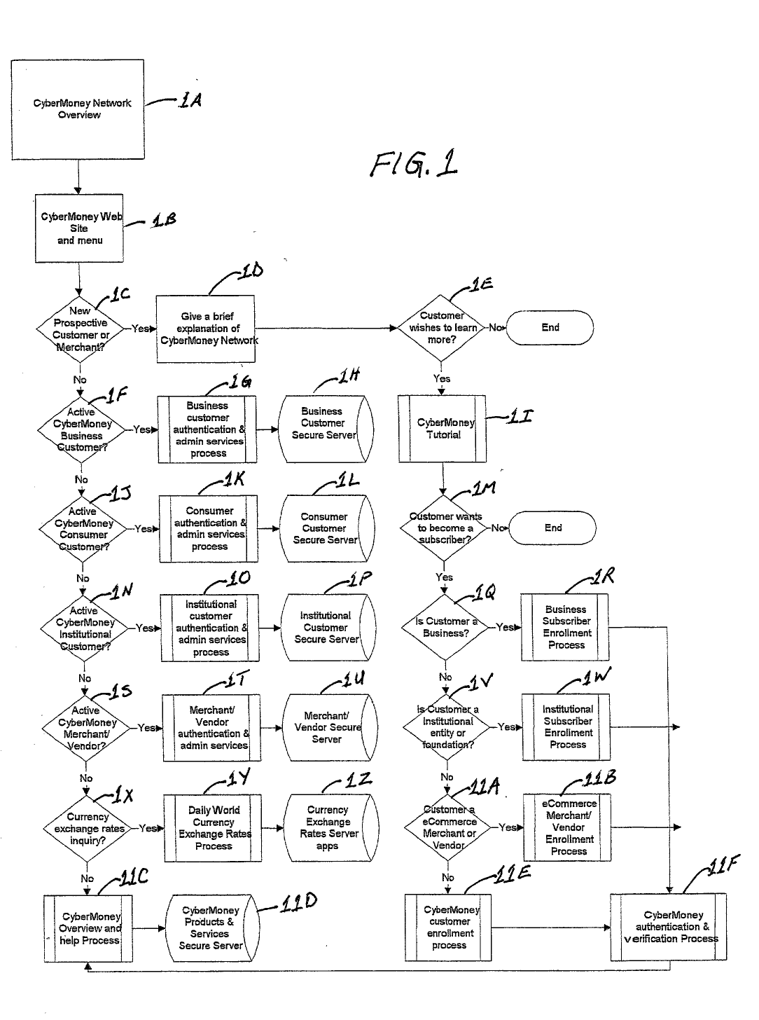

FIG. 1 is a flowchart comprised of web site interaction logic for new and existing network users.

The proposed seamless network overview 1A, begins with process by which a user comes to the web site for direct interaction with network services. Upon viewing the initial user menu 1B, the user has the option of selecting service as a new customer or merchant 1C, a business customer only 1F, a consumer customer only 1J, an institutional customer such as a hospital or university 1N or as a merchant/vendor 1S. The customer also has an initial option of viewing current currency exchange rates 1X. Otherwise, the user has the option to select help for navigating the site 11C and can be granted access to a list of product, services, banks and merchants members of the network 11D.

If the user is new to the network, a brief description of network services is given ID. In addition, if user wishes to obtain more detailed information 1K, a tutorial 11, is presented and the user is asked to become a subscriber to the network 1M. If the user is a business 1M, the business member enrollment process is evoked 1R. If the user is an institution or foundation 1V, the institution member enrollment process is evoked 1W. If the user is a web merchant/vendor 11A, the eCommerce/web merchant enrollment process is evoked 11B. Otherwise, regular customer membership enrollment processing is evoked 11E. At the end of each membership enrollment processing, network authentication and verification processing is initiated 11F and the user is prompted to view the network overview and help process 11C.

Upon initial web site entry, if the user is an existing network business customer 1F, authentication of user identity is initiated 1G, and access to user-specific business account administrative services is granted upon authorization 1H.

Upon initial web site entry, if the user is an existing network consumer customer 1J, authentication of user identity is initiated 1K, and access to user-specific consumer account administrative services is granted upon authorization 1L.

Upon initial web site entry, if the user is an existing network institutional customer 1N, authentication of user identity is initiated 10, and access to user-specific institutional account administrative services is granted upon authorization 1P.

Upon initial web site entry, if the user is an existing network merchant/vendor customer 1S, authentication of user identity is initiated 1T, and access to user-specific merchant/vendor account administrative services is granted upon authorization 1U.

Upon initial web site entry, the user has the ability to view daily currency exchange rates 1X. If this process is selected 1Y, the user is granted access to query the database of dynamically produced exchange rates.

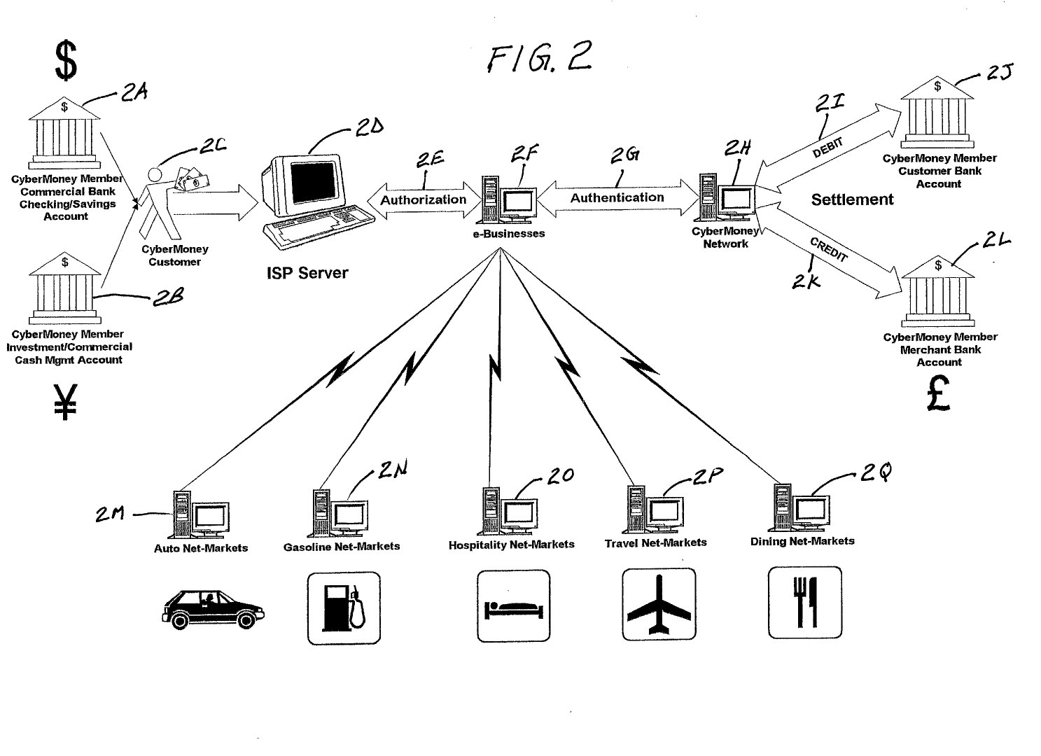

FIG. 2 is the detailed network payment and settlement process data flow.

The primary focus and function of the network is to provide an agnostic universal front-end and connectivity interface for commercial and investment bank accounts. This process is illustrated by an overview of the payment and settlement data flow as follows.

A typical network customer 2C, is empowered with an established commercial bank checking or savings account 2A, or commercial bank/investment bank cash management account 2B. Upon connection to the INTERNET via a local area network or an INTERNET SERVICE PROVIDER (ISP) 2D, the user proceeds to purchase goods or services from an INTERNET merchant or eBusiness 2F. Among the many purchase and payment options, the user selects the seamless payment and settlement network as payment option of choice. Once this selection is made, an authorization 2E and authentication query 2G, is made to the network secure server 2H. If the customer identity is authenticated 2G and customer account 2J, balance is sufficient, successful transaction authorization 2E, is transmitted to customer 2C and merchant 2F.

According to back-office settlement procedures jointly prescribed by the network, customer commercial/investment bank and merchant commercial/investment bank, account reconciliation and settlement whereby customer account 2J is debited 21 and merchant account 2L is credited 2K. Examples of various web merchants or exchange markets such as automobile 2M, gasoline 2N, hotel and hospitality 20, travel 2P and dining 2Q, are some of the many merchant/eBusinesses that would benefit from this invention process.

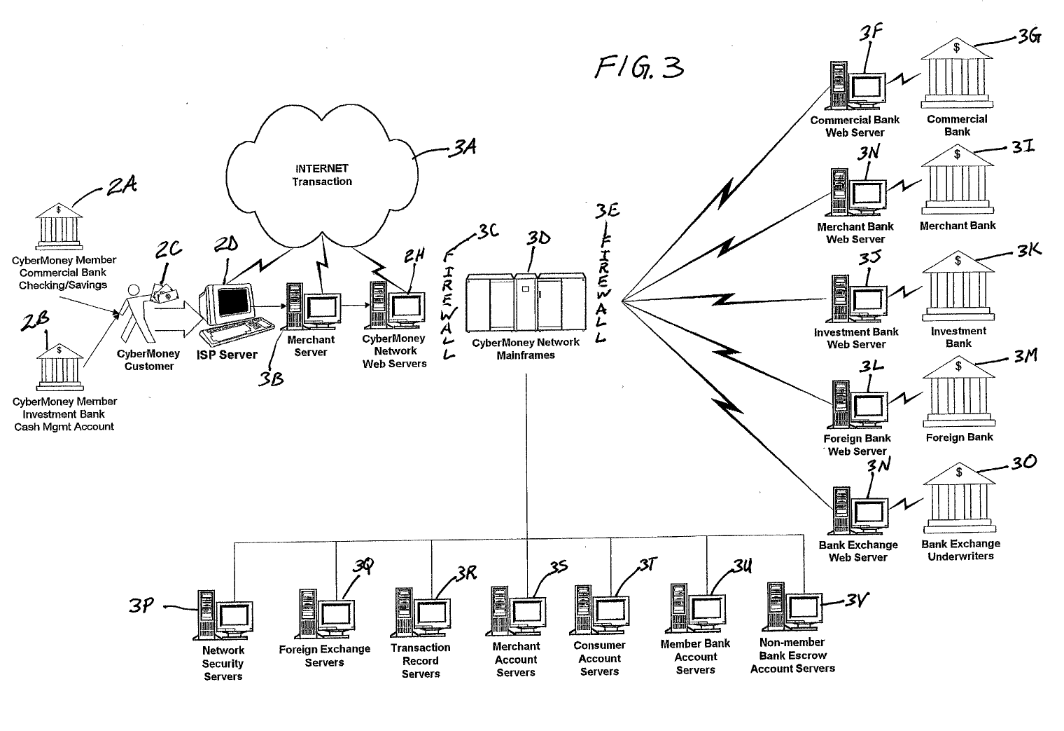

FIG. 3 represents the network architecture and server topology.

Since the network architecture and topology are central to the implementation of this invention, specific network integration components give clarity to connectivity architecture.

As the network customer 2C connects to the INTERNET via an ISP server 2D and engages in a INTERNET transaction 3A, for the purchase of goods or services from a web merchant via the merchant server 3B, the merchant server 3B communicates to the seamless network web server 2H and evokes transaction authorization and customer authentication. The seamless network web server facilitates connection to the network mainframe host computer 3D after analysis of transaction security parameters via a intranet firewall 3 C.

The network security server 3P sends a query to customer 2C for customer identification. Based upon customer response, network security server 3P checks for customer membership demographics and authentication methodology such as biometric or password authentication processing. The network security server 3P sends the customer a request for the necessary authentication method entry.

If authentication is successful, the merchant account server 3S or the consumer account server 3T is checked for the adequacy of account balance to cover transaction purchase. If authentication is not successful, a message is sent to customer 2C, requesting verification and re-entry. This is done no more than two or three times, based upon security parameters. Predicated on account balance and dynamic credit analysis procedures stored in member bank servers 3U, providing the funding of commercial bank account 2A or investment bank account 2B, successful transaction authorization is sent to customer 2C and merchant server 3B. The transaction is then logged in the transaction record server 3R database.

The settlement and reconciliation process involves the back-office processing procedures whereby member bank servers 3T contains member bank reconciliation and settlement process procedures. If for any reason a verified and credit-worthy bank/merchant customer 2C is involved in a transaction without an active network commercial bank 2A or investment bank 2B account, reconciliation and settlement will be made through strict processing procedures contained in the nonmember bank escrow account server 3V.

Daily updates to member bank account server 3U data and account information is processed through an exclusive firewall protected 3E, virtual private network (VPN) interface to a network of commercial bank web servers 3F, merchant bank web servers 3H, investment bank web servers 3J, foreign commercial bank web servers 3L and collective bank clearinghouse web servers 3N.

If authentication is not successful, a message is sent to customer 2C, requesting verification and re-entry. This is done no more than two or three times, based upon security parameters.

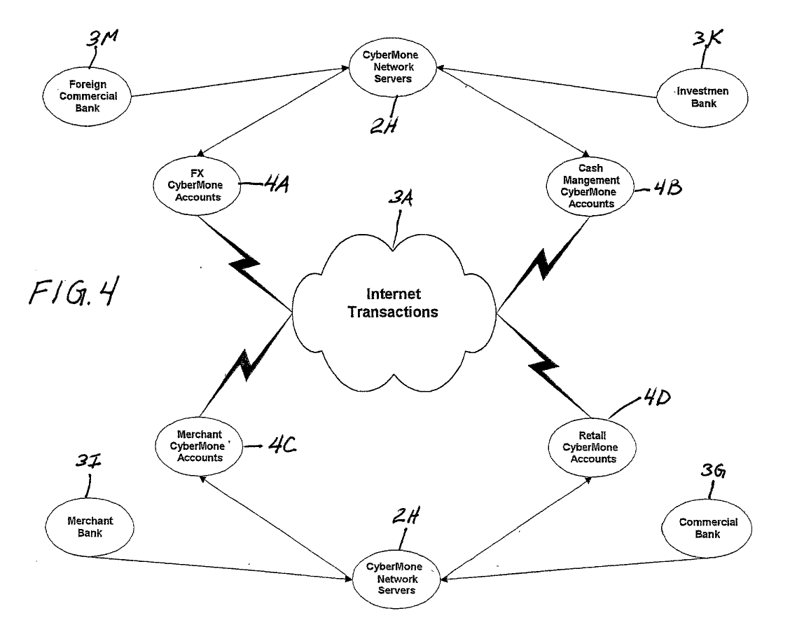

FIG. 4 is comprised of the graphical depiction of the various empowered network account types.

This graphic provides detail illustration of the relationship between the various bank accounts and the seamless network account interface. With respect to an INTERNET transaction 3A, the seamless network server 2H provides a universal front-end for empowering an investment bank 3k, cash management network accounts 4B for greater utilization and income generation. The seamless network server 2H provides a universal agnostic front-end for any commercial bank 3G retail network account 4D for greater customer acquisition and retention. In addition, the seamless network server 2H empowers merchant bank 31 merchant/vendor accounts 4C by providing expedient access to and cost-efficient use of funds collected. Moreover, the seamless network server 2h empowers global and foreign commercial banks 3M by extending their reach across continents with cost-efficient foreign currency exchange account facilities 4A.

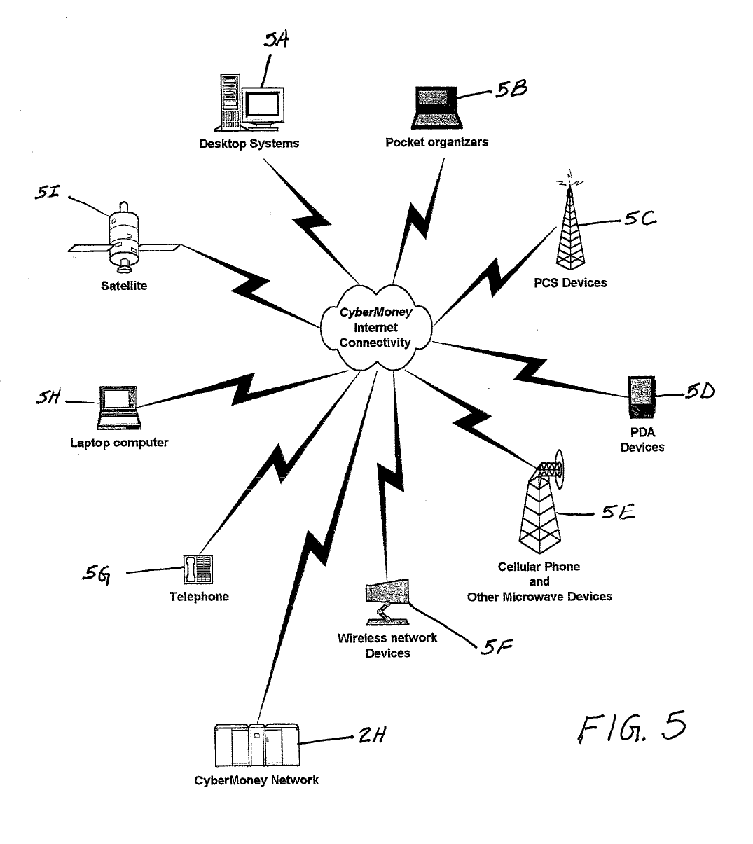

FIG. 5 illustrates the various INTERNET connectivity mediums in which the network can be accessed.

The INTERNET is a dynamic and continuously evolving mechanism of commerce and information. By reason of its ever-widening reach and dept, a wide variety of connectivity mediums abound. This seamless network platform 2H and all of its application programming interface constructs are device agnostic. As a result, the network enables multiple INTERNET connectivity mediums such as: web-enabled desktop systems 5A; pocket organizers 5B; personal communication systems devices (PCS) 5C; personal digital assistants (PDAs) SD; cellular and microwave based devices 5E; wireless devices 5F; digital phones 5G; laptop computers 5H and satellite based communication devices 51.

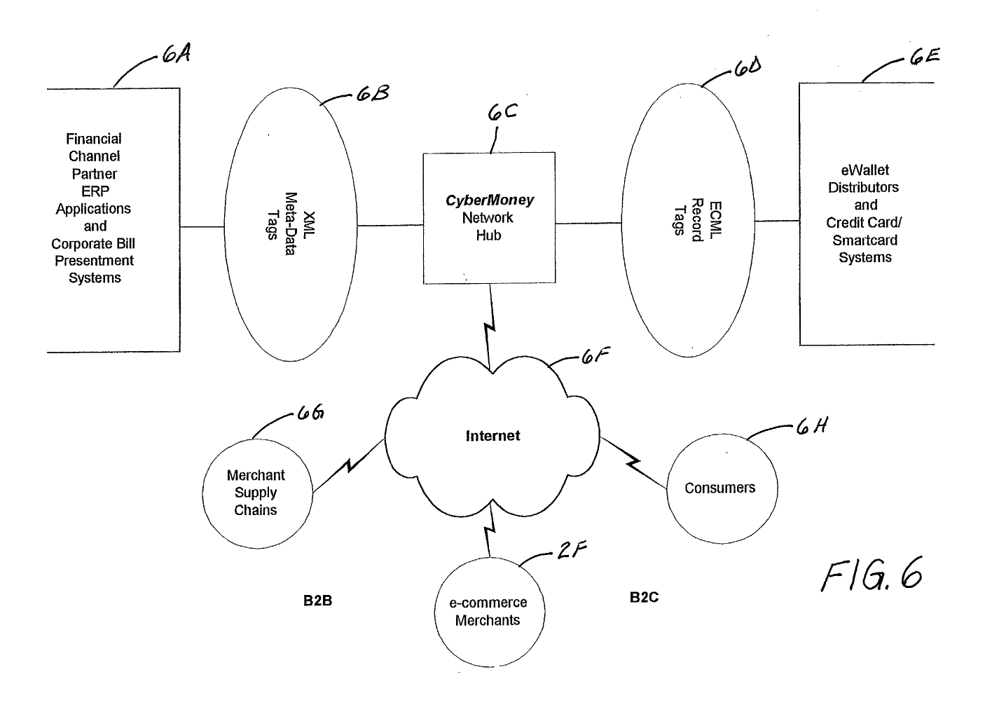

FIG. 6 denotes the application architecture of the network application programming interface components.

The network applications interface embraces open-end architecture for robust network compatibility across a broad spectrum of different computer systems and hardware. The front-end web site graphical user interface incorporates the latest convention of hypertext markup language called “Extended Markup Language,” or XML meta-data tags 6B. This enables compatibility with commercial and investment bank computer systems that have existing enterprise resource planning (ERP) and bill presentment system solutions 6A.

In an effort to ensure compatibility with all commercially available eWallet 6E constructs and systems, the network adheres to universal standards for wallets and merchant web sites set forth in a format know as Electronic Commerce Modeling Language (ECML) tags 6D. ECML uses a set of uniform field names that streamlines the process by which merchants collect electronic data for shipping, billing and payment. Our seamless network architecture includes an agnostic eWallet interface for universal wallet compatibility, providing seamless INTERNET connectivity integration.

The seamless network topology enhances the customer experience within business-to-business transactions between merchant supply chains 6G and web merchants 2F, as well as business-to-consumer transactions between web merchants 2F and consumers 6H.

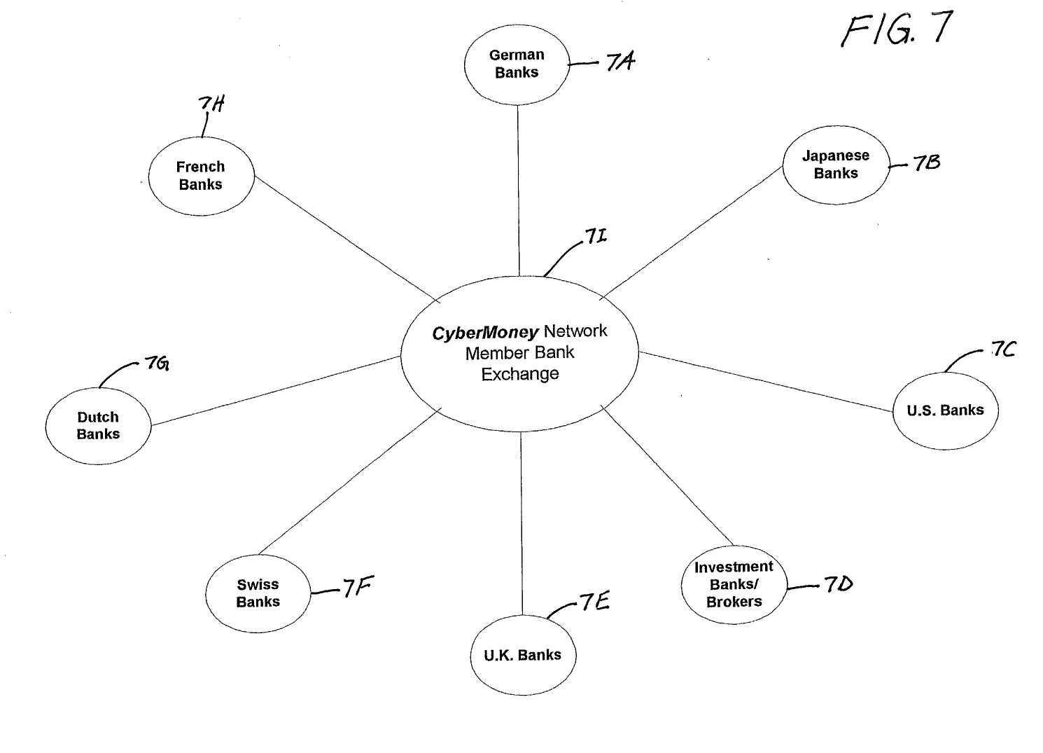

FIG. 7 represents the global banking syndication method for distributing network connectivity

The comprehensive strategy and unique focus of seamless network connectivity is best implemented through a truly global architecture as illustrated by FIG. 7. We have identified optimum initial network server market venues of which 8 are graphically depicted. These included: German banking market 7A, the Japanese banking market 7B, the U.S. banking market 7C, the global investment banking/brokerage market 7D, the United Kingdom banking markets 7E, the Swiss banking markets 7F, the Dutch/European banking markets 7G and the French banking markets 7H. The methodology of global INTERNET bank account syndication 71, culminates into an efficient exchange of global and seamless INTERNET financial payment and settlement.

1. A method of enabling seamless payment and settlement of goods and services purchased through the global INTERNET network platform, said method comprising:
a) an open architecture of application programming interface constructs for connecting a network of INTERNET merchants, consumers, INTERNET supply chain exchanges, INTERNET marketplaces and financial depository accounts for payment and settlement of purchases through the INTERNET and
b) a cluster of network servers connected to regional and global commercial, retail and investment bank customer demand deposit and cash management accounts or replicates of said accounts
c) means for connecting to retail customer demand deposit and cash management accounts to the INTERNET;
d) means for connecting to merchant demand deposit and cash management accounts to the INTERNET;
e) means for connecting to institutional customer demand deposit and cash management accounts to the INTERNET;
f) means for connecting to and providing escrow accounts for commercial, retail and investment bank compensating balances for INTERNET purchases;
g) means for enabling the universal connectivity to demand deposit and cash management accounts through various mediums of wired and wireless INTERNET connectivity;
h) means for enabling the payment and settlement of purchases over the INTERNET through universal account reconciliation methodology;
i) means for dynamically converting and exchanging account values predicated upon global foreign currency exchange methodology

2. A method of enabling seamless INTERNET payment and settlement according to claim 1, wherein said demand deposit accounts could consist of checking, savings, money market, certificate of deposits and cash management account facilities

3. A method of enabling seamless INTERNET payment and settlement according to claim 2 wherein network account connection interface applies to INTERNET connectivity appliance via wireless technologies

4. A method of enabling seamless INTERNET payment and settlement according to claim 3 wherein network account connection interface applies to INTERNET connectivity appliance via personal digital assistant technologies

5. A method of enabling seamless INTERNET payment and settlement according to claim 4 wherein network account connection interface applies to INTERNET connectivity appliance via desktop, workstation or laptop computer technologies

6. A method of enabling seamless INTERNET payment and settlement according to claim 5 wherein network account connection interface applies to INTERNET connectivity appliance via cellular or microwave technologies

7. A method of enabling seamless INTERNET payment and settlement according to claim 6 wherein network account connection interface applies to INTERNET connectivity appliance via satellite technologies

8. A method of enabling seamless INTERNET payment and settlement according to claim 7 wherein network account connection interface applies to INTERNET connectivity appliance via PCS technologies

9. A computer application that controls the network servers which provides for a seamless, wired or wireless agnostic front-end interface for any domestic or foreign commercial, retail or investment bank account, enabling payment and settlement of purchases of goods and services over the INTERNET

10. A method of enabling seamless INTERNET payment and settlement according to claim 9 wherein access to the network is controlled through integration of password, digital keys and biometric technologies

11. A method of enabling seamless INTERNET payment and settlement according to claim 10 wherein access to the network is controlled through integration of iris and retina scan recognition technologies

12. A method of enabling seamless INTERNET payment and settlement according to claim 11 wherein access to the network is controlled through integration of voiceprint recognition technologies

13. A method of enabling seamless INTERNET payment and settlement according to claim 12 wherein access to the network is controlled through integration of fingerprint recognition technologies

14. A method of enabling seamless INTERNET payment and settlement according to claim 13 wherein access to the network is controlled through integration of human tissue and cell recognition technologies

15. A method of enabling seamless INTERNET payment and settlement according to claim 14 wherein access to the network is controlled through integration of a hybrid construct of private digital certificate keys and encryption algorithms

16. The process of customer initiating connection to a merchant over the INTERNET and the customer initiating payment via said process whereby seamless payment and settlement of purchase via said seamless network interface ensues
a) Customer initiates payment sequence by selecting said network icon
b) Selection triggers connection to said seamless network platform
c) Seamless network platform is engaged
d) System prompts customer for identification number and security access protocol previously selected by customer
e) If a valid customer and authentication is successful, transaction completed, if non-valid id and security protocol initiated, notification of unsuccessful transaction completion is transmitted to customer and merchant and logged accordingly authorization is withheld
f) If a valid customer and authentication is successful, authorization of transaction is transmitted to merchant and customer
g) Currency exchange and account settlement process according to customer evoked parameters
h) Internal account reconciliation is facilitated
i) Customer account or replicate account abstract is debited
j) Merchant account or replicate account abstract is credited

17. Each transaction is indexed and logged to global transaction repository where dynamic daily, weekly and monthly account reconciliation and settlement of accounts are processed

18. Customer, merchants and institutions may subscribe to network membership by way of direct web server interface as well as commercial and investment bank online or offline office
